(19) United States
(12) Patent Application Publication
(10) Pub. No.: US 2016/0373297 A1
(43) Pub. Date: Dec. 22, 2016

(54) DEVICE, SYSTEM, AND METHOD FOR MANAGING VIRTUAL AND PHYSICAL COMPONENTS OF A NETWORK VIA USE OF A REGISTRY

(71) Applicant: AT & T Intellectual Property I, L.P., Atlanta, GA (US)

(72) Inventors: John NG, Morganville, NJ (US); Dean Bragg, Toms River, NJ (US); Mark Jeffrey Foladare, East Brunswick, NJ (US); Robert M. Higgins, Manasquan, NJ (US)

(21) Appl. No.: 14/743,465

(22) Filed: Jun. 18, 2015

(51) Int. Cl. H04L 12/24; G06F 9/455

(52) U.S. Cl. CPC H04L 41/0806; G06F 9/45558; H04L 41/04; G06F 2009/45595

(57) ABSTRACT

A device and method manages components of a network. The method performed in a registry includes recording, for an instantiated component (IC), an identification thereof. The method includes recording, for the IC, a location of the IC, the location being a physical location or a virtual location. The method includes recording, for the IC, a relation of the IC to a second IC. The method includes receiving a change to one of the identification, the location, and the relation. The method includes recording the change and a further change to another one of the identification, the location, and the relation based upon the change.

### BACKGROUND INFORMATION

A service provider may provide a plurality of services to a plurality of users. Specifically, the services may relate to network functions in which the users utilize a respective electronic device configured to connect to a communications network. While connected to the network, the network functions may be accessed by the user through the electronic device. The service provider may provide these network functions through network devices that create instances of the network functions for the user when requested.

In conventional network architectures for service providers, the network function may be associated with a specific network device such that the network device and the network function are manufactured and sold together with purpose-built hardware. This manner of network function deployment for the users provide a relatively simple manner of tracking between the software aspect (the network function) and the hardware aspect (the network device). However, the network function is inseparable from the network device and results in a highly inflexible and expensive system. For example, for a specific network function, only the corresponding network device is capable of providing the service to the user. In another example, to provide a new service including a new network function, a new hardware component is required.

To compensate for the inflexible nature using the above manner of providing services, a network function virtualization scheme has been provided where a network device is not limited to only providing predetermined network functions. In contrast, the virtual network function may be substantially equivalent to a corresponding network function but instantiated onto any available network device that is capable of providing the service. Accordingly, the network function virtualization scheme essentially separates the network function from the network device and enables a flexible and more cost efficient system. Therefore, the network function software may be purchased alone and executed on inexpensive general purpose hardware platforms. Furthermore, multiple virtual network functions may be run on a single piece of hardware.

Although the network function virtualization scheme provides a remedy for various issues associated with conventional network architectures, the network function virtualization scheme does not allow for easy tracking based on the inseparability associated with conventional network architectures. Since the virtual network function is instantiated on a virtual machine which is then associated with any available network device and the capability of having a plurality of virtual network functions on a single network device, the association between the virtual network function and the network device must be tracked separately as the hardware and software do not have a one-to-one correspondence. Furthermore, during operations, virtual network functions may be dynamically moved from one instance to another instance, from one network device to another network device, from one geographic location to another geographic location, etc. This feature is also part of the flexible nature of network function virtualization but the management and tracking of the hardware and software becomes more challenging and requires significantly more processing.

### SUMMARY

The exemplary embodiments describe a method for managing virtual and physical components of a network via a registry. The method comprises, in a registry, recording, for an instantiated component (IC), an identification of the IC; recording, for the IC, a location of the IC, wherein the location is one of a physical location or a virtual location; recording, for the IC, a relation of the IC to a second IC; receiving a change to one of the identification, the location, and the relation; and recording the change and a further change to another one of the identification, the location, and the relation based upon the change.

The exemplary embodiments describe a registry device for managing virtual and physical components of a network via a registry. The registry device comprises a network interface component configured to establish a connection to a network system; and a processor configured to generate a registry by recording, for an instantiated component (IC) of the network system, an identification of the IC, recording a location of the IC, wherein the location is one of a physical location or a virtual location, and recording a relation of the IC to a second IC, the processor configured to maintain the registry by receiving a change to one of the identification, the location, and the relation and recording the change and a further change to another one of the identification, the location, and the relation based upon the change.

The exemplary embodiments describe a non-transitory computer readable storage medium with an executable program stored thereon, wherein the program instructs a microprocessor to perform operations for managing virtual and physical components of a network via a registry. The operations comprise, in a registry, recording, for an instantiated component (IC), an identification of the IC; recording, for the IC, a location of the IC, wherein the location is one of a physical location or a virtual location; recording, for the IC, a relation of the IC to a second IC; receiving a change to one of the identification, the location, and the relation; and recording the change and a further change to another one of the identification, the location, and the relation based upon the change.

### BRIEF DESCRIPTION OF THE DRAWINGS

FIG. 1 shows a network system according to the exemplary embodiments.

FIG. 2 shows a registry device of FIG. 1 according to the exemplary embodiments.

FIG. 3 shows a reference system according to the exemplary embodiments.

FIG. 4 shows a method for managing a network registry according to the exemplary embodiments.

### DETAILED DESCRIPTION

The exemplary embodiments may be further understood with reference to the following description of the exemplary embodiments and the related appended drawings, wherein like elements are provided with the same reference numerals. The exemplary embodiments are related to a device, system, and method for managing virtual and physical components of a network. Specifically, the exemplary embodiments maintain and update a registry that records instantiated components (IC) and all related information corresponding to the IC both directly and indirectly. Accordingly, the registry may be used in a variety of ways to not only track virtual network functions, physical network functions, virtual machines, and physical network devices but also provide various views across the different layers associating the ICs.

Initially, it is noted that the term IC used herein may relate to both a physical object, a virtual object, or an informational object. Although the term “component” may be used herein to relate to devices (both physical and virtual), the IC is used herein to further represent other forms of objects relevant to the exemplary embodiments as will be clear from the description below. Specifically, the IC may represent any instance of an object (physical, virtual, informational, etc.). As will become evident below, the IC may therefore include a customer identification, a product identification, a service identification, a virtual network function, a physical network function, a virtual machine, a hardware device, etc.

The exemplary embodiments relate to managing and tracking relationships in a network function virtualization (NFV) paradigm between virtual network resources and services and a temporal relationship with physical locations and physical hardware the virtual resources/services reside on at any point in time. Those skilled in the art will understand the separate nature between virtual network resources/services to the physical location/hardware. Accordingly, unlike traditional networking architectures, the management and tracking between these virtual and physical aspects in the NFV are not done on offline data stores or one data store per network domain. Also unlike traditional networking architectures, the identification of the location of the network resource cannot be statically embedded to the location via its name or attributes of the resource. The flexible and highly adaptive manner that NFV operates prevents the mechanism used in traditional networking architectures to be ported to the NFV, particularly in view of latency and data synchronization issues. Accordingly, the virtual network functions' creation (e.g., service activation), deletion (e.g., service disconnect), or movement to another network device (e.g., due to congestion relief or hardware failure) is part of a constant stream of activities in the network, making it difficult for static databases to handle and stay in synchronization with the network. The exemplary embodiments generate the registry to address these issues.

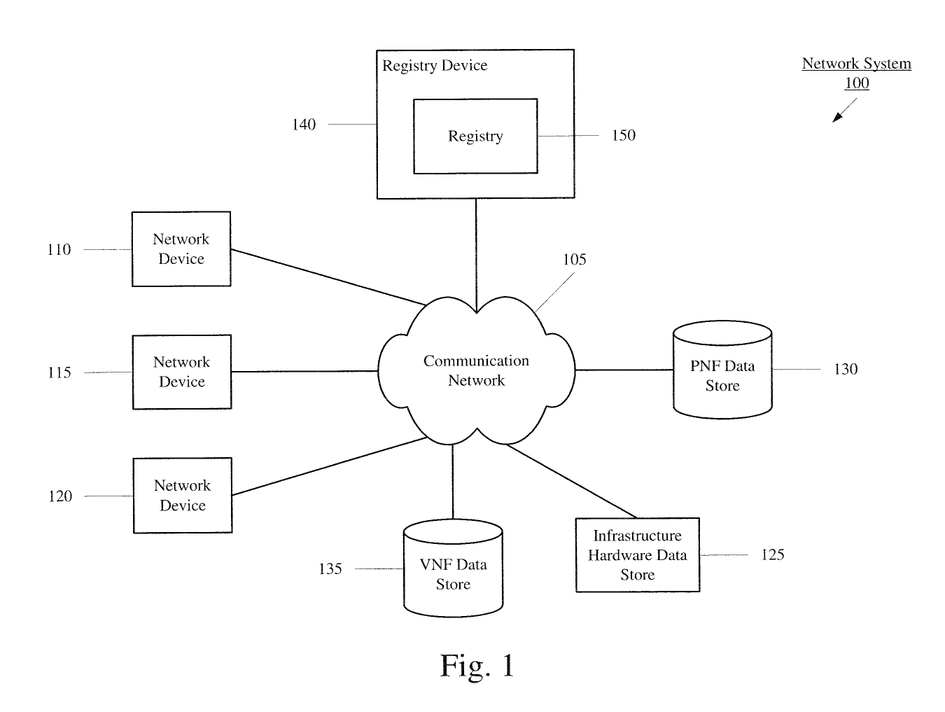

FIG. 1 shows a network system 100 according to the exemplary embodiments. The network system 100 may represent any network configured to utilize the NFV mechanism of providing network functions and services. Accordingly, the network system 100 may include a communication network 105, a plurality of network devices 110-120, an infrastructure hardware data store (HDS) 125, a physical network function (PNF) data store (PDS) 130, and a virtual network function (VNF) data store (VDS) 135. Furthermore, the network system 100 may include a registry device 140 that maintains and updates a registry 150.

Initially, the NFV is a network architecture in which network functions and network services are virtualized. The NFV may further categorize the functions and services into network node functions that are to be virtualized. These network node functions may form the bases upon which the services are ultimately created and provided through different connections among the virtualized and physical features. Through decoupling the network functions (e.g., network address translation (NAT), domain name service (DNS), firewalling, intrusion detection, caching, etc.) from the hardware to be run in the software in the NFV mechanism, a VNF may include one or more virtual machines (VM) that run different software and processes on different network components such as servers, switches, and storage and may further utilize a cloud infrastructure. The NFV consolidates and delivers networking features needed to support a fully virtualized infrastructure. Therefore, the NFV mechanism provides a virtualization in its design, deployment, and management of network services.

The communication network 105 may be any network including a plurality of devices that enable data to be exchanged between the devices of the network and any devices connected to the network. The communication network 105 may be any type of network such as a local area network (LAN), a wide area network (WAN), a wired format, a wireless format, a WiFi network, a HotSpot network, a 3G/4G/LTE network, the Internet, etc. The communication network 105 may include one or more networks where each network may be any of these network types. Accordingly, the communication network 105 may include internetwork and intranetwork devices that enables the data to be exchanged. The communication network 105 may particularly be utilized by a service provider to provide services to a user device. Accordingly, the service provider may have various network devices (not shown) such as servers, routers, switches, network management arrangements, etc. within the communication network 105. In this manner, the communication network 105 represents any network or plurality of networks that enable the data to be transmitted from a first device to a second device where the first and second devices may be network devices or user devices.

The network devices 110-120 may be the physical hardware that is capable of executing a plurality of processes, programs, and/or applications. The network devices 110-120 may accordingly be associated with a particular service provider that is configured to execute select network functions that comprise a given service for a user device. Thus, the network devices 110-120 may include the necessary hardware and software so that the different network functions may be executed thereon. The network devices 110-120 may be configured to execute a plurality of the network functions as well as select or all of the network functions based upon the configuration installed respectively on each of the network devices 110-120. The network devices 110-120 may be physically located in a variety of locations such as in geographically similar or distant areas.

The HDS 125 may be an information storage component that stores information related to the various network devices 110-120. Specifically, the HDS 125 may store specifics regarding each of the network devices 110-120. For example, the specifics may include a model number, a serial number, a product type, a manufacturer identification, a physical location, etc. Accordingly, the HDS 125 may be updated for each network device 110-120 that is added, removed, replaced, changed, etc.

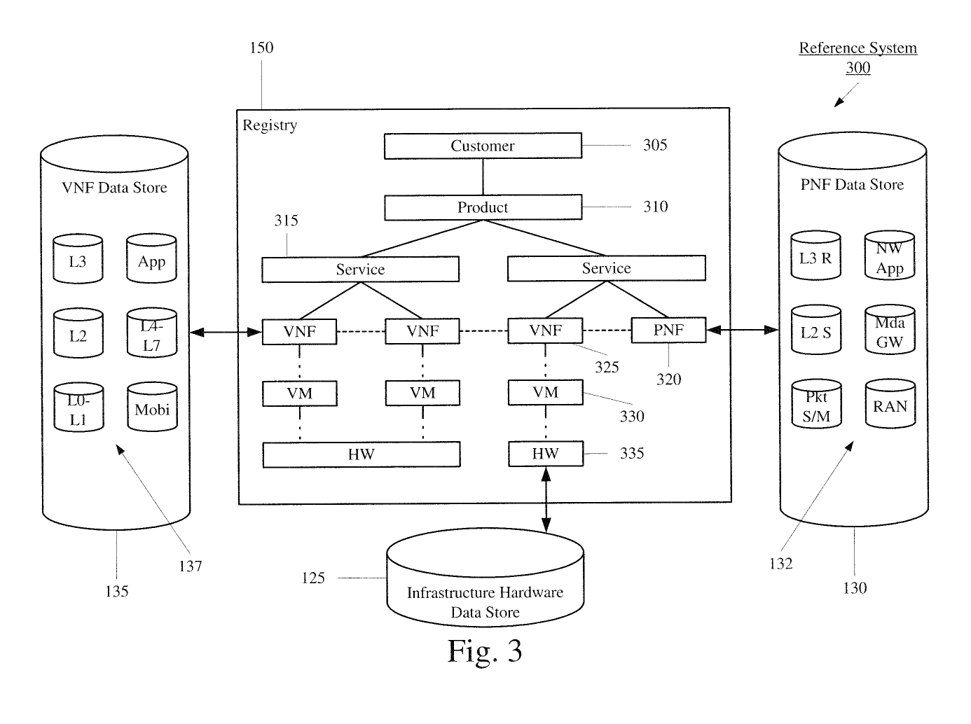

The PDS 130 may be an information storage component that stores information related to the PNFs. Initially, the PNF may be substantially similar to the network functions in conventional network architectures. Specifically, the PNF may be comparable to the network function established with a network device. Accordingly, the connection and relationship of the PNF may be predetermined and known at all times with a specific network device. For example, one of the network devices 110-120 may be manufactured with the hardware and software to perform a specific network function. That is, the PNF may be tied to the network device. It should be noted that the PNF may be performed on multiple network devices 110-120. For example, a first portion of the PNF may be performed on one of the network devices 110-120 while a second portion of the PNF may be performed on another, different one of the network devices 110-120. Thus, the PNF may have a relationship with one or more network devices 110-120. The PDS 130 may store this information. Thus, if any of the network devices 110-120 is configured with a PNF, the PDS 130 may indicate this relationship. More specifically, the PDS 130 may include sub-PNF data stores 132 (as illustrated in FIG. 3). The sub-PNF data stores 132 may include, for example, layer 3 routers, layer 2 switches, packet optical switch/muxes, network application servers, media gateways, radio access network (RAN) nodes, etc. These sub-PNF data stores 132 may track the PNFs in the PDS 130.

The VDS 135 may be an information storage component that stores information related to the VNFs. Initially, the VNF may be the above described feature of performing the network function on an available network device 110-120. That is, the network function corresponding to the VNF may be a separate aspect from the network devices 110-120 such that the VNF may be assigned to any one of the network devices 110-120. It should be noted that the VNF may only be assigned to select ones of the network devices 110-120 that is configured to support the VNF. For example, if the network devices 110, 115 are configured to support the network function but the network device 120 is not configured, the VNF may only be selected to be assigned to the network devices 110, 115 while the network device 120 is omitted from consideration. It should be noted that like the PNF, the VNF may also be performed on multiple network devices 110-120. For example, a first portion of the VNF may be assigned to one of the network devices 110-120 while a second portion of the VNF may be assigned to another, different one of the network devices 110-120. Thus, the VNF may have a relationship with one or more network devices 110-120. The VDS 135 may store this information. Thus, if any of the network devices 110-120 is assigned a VNF, the VDS 135 may indicate this relationship. More specifically, the VDS 135 may include sub-VNF data stores 137 (as illustrated in FIG. 3). The sub-VNF data stores 137 may include, for example, level 0 to 1 VNFs, level 2 VNFs, level 3 VNFs, level 4 to 7 VNFs, application VNFs, mobility VNFs, etc. These sub-VNF data stores 137 may track the VNFs in the VDS 135.

It should be noted that the network system 100 illustrated in FIG. 1 is only exemplary in a variety of manners. In one aspect, the number of the different devices being shown is only exemplary. In a first example, as discussed above, the communication network 105 may include one or more individual networks that may be connected with one another. In a second example, the number of network devices 110-120 is only exemplary. Those skilled in the art will understand that there may be any number of network devices 110-120 to satisfy any load requirement, network function provision, backup requirement, etc. In a third example, there may be any number of HDS 125, PDS 130, and VDS 135. For example, there may be a HDS 125 for the network devices 110-120 in a given geographic region, by network function capability, etc.; there may be a respective PDS 130 for given sets of PNFs; there may be a respective VDS 135 for given sets of VNFs.

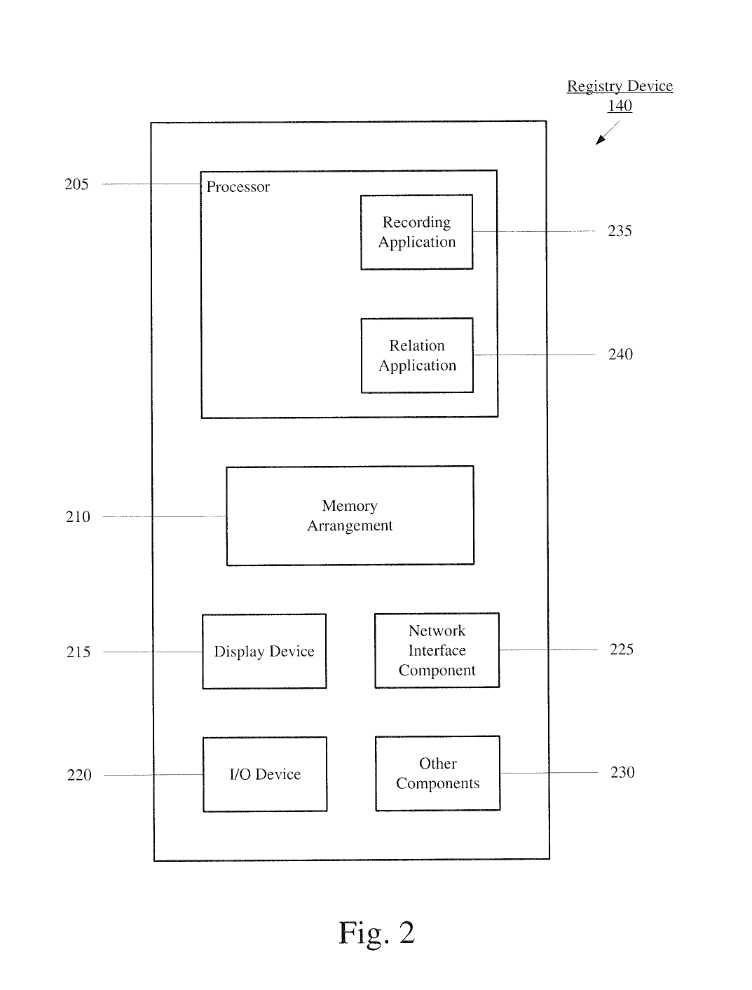

According to the exemplary embodiments, the registry device 140 may update and maintain the registry 150 that stores all the relationships of the network devices 110-120, the PNFs, the VNFs, etc. FIG. 2 shows the registry device 140 of FIG. 1 according to the exemplary embodiments. The registry device 140 may represent any electronic device (e.g., a portable device or a stationary device). The registry device 140 may include a processor 205, a memory arrangement 210, a display device 215, an input/output (I/O) device 220, a network interface component 225, and other components 230 such as the portable power supply, an audio I/O device, a data acquisition device, ports to electrically connect the registry device 140 to other electronic devices, etc.

It should be noted that the registry device 140 being a separate device configured for the functionalities described herein is only exemplary. The functionalities, the processing, the operations, etc. corresponding to the registry device 140 may also be performed by a separate device, by one of the network devices 110-120 (that may also execute a network function), by a server, by a switch, etc.

The processor 205 may be configured to execute a plurality of applications of the registry device 100. Specifically, the processor 205 may execute a recording application 235 and a relation application 240. The recording application 235 may be configured to receive information from a variety of sources including the relation application 240 to maintain and update the registry 150. For example, the recording application 235 may receive information of a new network device and include this information (e.g., select portions of the information used for the registry 150) in the registry 150.

The relation application 240 may be configured to determine subsequent updates to the registry 150 in view of any updates applied to the registry 150. As indicated above, the relation application 240 may be a source of information for the recording application 235. For example, the recording application 235 may update the registry 150 with the new network device. Accordingly, the relation application 240 may monitor the registry 150 for this update and perform various processes and operations to determine how this new network device is included in the network system 100 (e.g., review new network topology) such that the relationships of the new network device are determined (e.g., connection to entry in HDS 125 of specifics of new network device). The relation application 240 may provide this information to the recording application 235 for the registry 150 to be updated accordingly. In another example, the recording application 235 may update the registry 150 with one of the network devices 110-120 being assigned a particular VNF or that the VNF has been moved from one of the network devices 110-120 to another one of the network devices 110-120. The relation application 240 may determine this update to the registry 150 and determine how this change affects the relationships within the network system 100 such as the VM and hardware that are now being used and higher level information such as the service, product, and customer to which this change relates. The relation application 235 may provide this information to the recording application 235 for the registry 150 to be updated accordingly.

It should be noted that the above description in the manner with which the recording application 235 and the relation application 240 is only exemplary. For example, the recording application 235 may update the registry 150 as an initial entry in the registry 150. Subsequently, the relation application 240 may detect this update to perform its functionality. However, the recording application 235 and the relation application 240 may operate in a substantially parallel manner such that the update to the registry 150 is performed as a single operation.

It should be noted that the above noted applications, being described as an application or a program executed by the processor 205, are only exemplary. The functionality associated with the applications may also be represented as a separate incorporated component of the registry device 140 or may be a modular component coupled to the registry device 140 (e.g., an integrated circuit with or without firmware). In addition, the functionality associated with the applications may be executed on different devices, on different processors, etc.

The memory arrangement 210 may be a hardware component configured to store data related to operations performed by the registry device 140. Specifically, the memory arrangement 210 may store data related to the recording application 235 and the relation application 240. For example, the information received by the recording application 235 may be stored for processing and the subsequent changes determined by the relation application 240 may be stored for processing.

The display device 215 may be a hardware component configured to show data to a user while I/O device 220 may be a hardware component configured to receive inputs from the user and output corresponding data. For example, although the registry 150 is used for other purposes, a user may select to use the registry device 140 to view the registry 150 such as for manual maintenance reasons. Accordingly, the display device 215 may show a user interface for the registry 150 while the I/O device 220 receives inputs to control the manner in which the registry 150 is viewed/used. The network interface component 225 may enable the connection between the registry device 140 and another device. Specifically, the network interface component 225 may enable the various information to be received by the recording application 235 (although a different exchange mechanism may be used with the relation application 240 particularly when both applications are executed by the registry device 140). For example, the updates or changes to the network devices, VNFs, PNFs, etc. may be received by the recording application 235 via the network interface component 225. The network interface component 225 may enable a wired or wireless connection with the further electronic device directly or indirectly such as via a network so that the information may be exchanged.

The above description provides a mechanism by which information is gathered by the registry device 140. The exemplary embodiments may utilize any manner for this information to be provided to the registry device 140. For example, when a VNF is determined and assigned or allocated to a network resource such as one of the network devices 110-120, a message may be generated and transmitted to the registry device 140. The message may be generated in an automated manner by any capable component that registers this feature. The message may also be generated manually by an administrator or other user, particularly when, for example, a new network device is added to the network system 100.

The exemplary embodiments maintain and update the registry 150 such that a plurality of different relationships may be managed and tracked. FIG. 3 shows a reference system 300 according to the exemplary embodiments. The reference system 300 illustrates the various relationships that may be tracked by the registry 150. Specifically, the reference system 300 illustrates relationships tracked by the registry 150 as well as associations with the various data stores such as the HDS 125, the PDS 130, the sub-PNF data stores 132, the VDS 135, and the sub-VNF data stores 137.

As illustrated in the reference system 300, the registry 150 may track the network functions both as a VNF 325 and a PNF 320. Once the VNF 325 and the PNF 320 have been generated as an instance, they may be forms of ICs. As discussed above, the IC may be any instance of a physical, virtual, or informational object. The VNF 325 and the PNF 320 may be considered to be on a common level when considering other ICs (to be discussed below). Also as discussed above, the registry 150 may track relationships. Specifically, the intra-relationships within a common level may be tracked such as between the VNF 325 and the PNF 320. The relationship between the VNF 325 and the PNF 320 may relate to a topology of network services instances. In this manner, the relationship may also be represented as a type of IC to be incorporated into the registry 150. As shown in the registry 150 of FIG. 3, there may be a plurality of VNF and the registry 150 may track each relationship of the VNFs to each other and with the PNF 320 (as well as any other PNF (not shown)).

The registry 150 may further track lower levels of objects or ICs. For example, the registry 150 may track lower levels including the VNF 325 being associated with the VM 330 as well as the hardware 335 associated with the VM 330. Initially, the VM 330 may emulate an actual electronic device to execute the assigned functionality such as the VNF 325. Those skilled in the art will understand that the VM 330 may include specialized hardware, software, or a combination of both to provide this functionality. Therefore, the VM 330 may be an IC when the VNF 325 is being performed thereon. The VM 330 may accordingly execute the VNF 325 on an actual, physical device such as the hardware 335 which may also be an IC. The registry 150 may accordingly track these relationships. The registry 150 may further track the relationships between the VNF 325, the VM 330, and the hardware 335. Those skilled in the art will understand the potentially volatile nature of these relationships. That is, these relationships may be dynamic associations that may change at any time such as utilizing a different hardware 335 should a failure occur on a currently used hardware 335. The registry 150 may also track these relationships as ICs.

The registry 150 may additionally track higher levels of objects or ICs. For example, the registry 150 may track higher levels including the service 315 that the VNFs 325 are associated as well as the product 310 for which service 315 is associated and even further the customer 305 for which the product is associated. In contrast to the volatile nature of the lower levels, the higher levels of ICs may have logical associations that persist during the life of the service or product instance. For example, a particular user may be the customer 305 who is registered with a service provider. The customer 305 may have also registered the product for which the service provider is to provide a selected set of services 315. To accomplish the services 315, at least one VNF 325 and/or at least one PNF 320 is required to be performed for the service 315 to be provided. In this manner, the logical association of the higher levels may persist. However, it should be noted that these associations may not be permanent and it is possible to be changed such as if the customer 305 were to add a new service or remove an existing service. In another example, a service 315 may be determined to be capable of being performed with a different set of VNFs and/or PNFs. The registry 150 may update and maintain each of these relationships in the higher levels as ICs for each object and association.

It should be noted that the registry 150 in the reference system 300 illustrated in FIG. 3 is only exemplary in a variety of manners. In one aspect, the number of the different ICs being shown is only exemplary. The registry 150 shows the potential ICs for a single customer 305 having a single registered product 310. However, the registry 150 may track each customer 305 and each of the possibly registered products 310 where one customer 305 may have one or more products 310. There may further be any number of services 315 where each service utilizes any number of VNFs 325 and/or PNFs 320 to support the service 315. In addition, the VNF 325 is illustrated as having a 1:1 ratio with the VM 330. However, the VNF 325 may utilize any number of VM 330 and the VM 330 may be performed on any hardware 335 (e.g., network devices 110-120). For example, as shown in FIG. 3, each VM 330 may be performed on a single hardware 335 or multiple VM 330 may performed on a common hardware 335.

Thus, the registry 150 may manage and track each of the above ICs including the object itself (e.g., customer 305, VNF 325, hardware 335, etc.) as well as the associations among each. Accordingly, from lower to higher, the registry 150 may track the relationships of the hardware 335 with the VMs 330, the VMs 330 with the VNFs 325 and the PNFs 320, the VNFs 325 and the PNFs 320 with the interfaces to other VNFs 325 and other PNFs 320, the network service 315 with the underlying VNFs 325 and PNFs 320 that support it, the product 310 with the network services 315, and the customer 305 with the subscribed products 310.

The registry 150 may therefore track and manage relationships and intra-associations from the customer 305 to the hardware 335. The registry 150 may also track and manage inter-associations. That is, the registry 150 may also track how the PNF 320 is associated with the PDS 130, how the VNF 325 is associated with the VDS 135, and how the hardware 335 is associated with the HDS 125. The registry 150 also employs a resilient method of housekeeping such that the registry 150 is constantly kept up-to-date and in sync with a current state of the network system 100. For example, when an object is instantiated, the IC is recorded in the registry 150 by identifying a variety of characteristics such as what the IC is (e.g., device, function, association, etc.), a state of the IC, a relation of the IC, a location of the IC, etc. Thus, if the IC were to change such as moving to a new location or changing its identity, the registry 150 re-records the IC to accurately reflect its state.

It should be noted that the registry 150 may be updated or may re-record an IC in a variety of different manners and times. In a first example, the registry 150 may be updated constantly whenever any change is received such as a move, a change in association, etc. In this manner, the registry 150 may be up-to-date at all times and ready for use. In a second example, the registry 150 may be updated at any time prior to use. Thus, when a user requires the information of the registry 150, the registry 150 may be collectively updated with all changes up to the point of request.

It is also noted that the registry 150 may include the information of the ICs in a variety of different manners. For example, the registry 150 may include the ICs and any associations in a minimal manner so that not all details are included but sufficiently enough context to manage identity and relationships. In contrast, the more detailed information or a complete information list of the ICs may be resident on the ICs themselves or in related data stores, the associations to which the registry 150 also tracks.

The registry 150 may be used for a variety of reasons. The up-to-date records included in the registry 150 may provide valuable information to a user who has a request regarding the network system 100. The registry 150 may support queries from any client system for any relationship and group of relationships for a comprehensive list of service and network management functions such as fulfillment, activation, performance, fault/troubleshooting, capacity planning, etc. These relationships of the ICs as recorded in the registry 150 may form the basis for generating domain-level topology graphs, customer network views, end-to-end service views across domains to facilitate the management functions, etc. The state of the underlying resources and services may also be stored and reflected. Thus, the registry 150 may provide a reference to other data stores to obtain more detailed data about a resource or service. Through the registry 150 being updated and in one embodiment, shared in real-time, the registry 150 may represent a comprehensive up-to-date view of the network in a hybrid physical and dynamic virtual environment linking resources, services, and customers for management needs.

The registry 150 may accordingly provide the information for both the PNF and the VNF. With regard to the PNF, the registry 150 may interface to planning and inventory systems that deploy and track physical hardware equipment and subscribe to events that reflect when a piece of network equipment or server hardware is active for service where the server hardware includes those used to virtualize the network functions. With regard to the VNF, the registry 150 may subscribe to real time events of creation, deletion, change of the VM, the VNF layer, the servers layer, any connectivity changes, association changes to customers and products, etc.

The registry 150 may provide information for a variety of different use cases. For example, the network system 100 may be for a service provider and the request may relate to addressing an issue with providing a service to a product used by a user. An administrator who receives the issue may track the issue from the customer (at the highest level) to the hardware (at the lowest level) and determine a source for why the service is not being provided as intended. In another example, the registry 150 may provide information for planning purposes. If a network device is determined to be deactivated, malfunctioning, decommissioned, etc., the planning system may determine that this network device is to be omitted from any consideration for use such as being assigned any further network function.

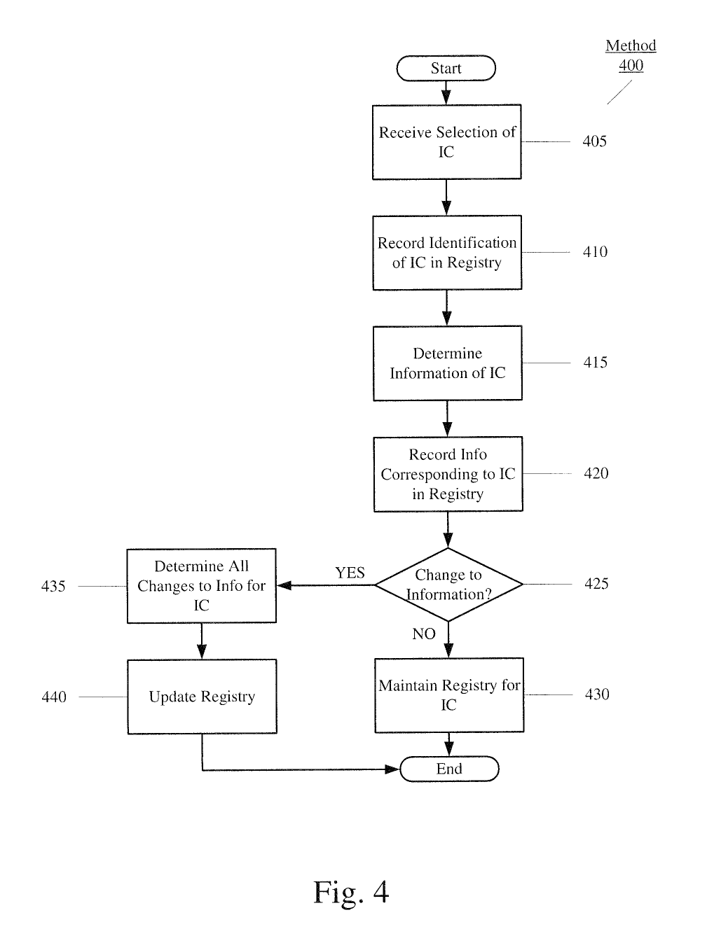

FIG. 4 shows a method 400 for managing a network registry 150 according to the exemplary embodiments. The method 400 relates to tracking and managing the ICs and associations in the registry 150 ranging from the network function in the form of VNFs 325 and PNFs 320 to the higher levels such as customer 305, product 310, and services 315 and lower levels such as VMs 330 and hardware 335. The method 400 also relates to tracking and managing the associations within a common level, with different levels, and with the various data stores. More specifically, the method 400 relates to an initial incorporation of the IC and subsequent tracking/managing of the IC. The method 400 will be described with regard to the network system 100 of FIG. 1 and the reference system 300 of FIG. 3.

In step 405, a selection for an IC may be received. For example, the IC may be any of the network functions (e.g., VNF or PNF), the machines associated with each network function (e.g., VM or network device 110-120), the higher level aspect (e.g., services or products), the associations (e.g., intra within a common level, inter between levels, or with data stores), etc. It should be noted that the “selection” of the IC may represent a generic procedure in which the IC or an identity of the IC is being indicated to the registry 150 for the subsequent operations to be performed.

In step 410, the registry device 140 may record an identification of the IC in the registry 150. The registry device 140 may record the identification in a variety of ways. In a first example, the identification may be recorded with a minimum amount for the identification to be sufficient. In a second example, the identification may be recorded if the IC is determined to be new with no previous entry already in the registry 150.

In step 415, the registry device 140 determines the information associated with the IC. For example, the IC may be the VNF 325. The information of the VNF 325 may include the VM 330 which executes the network function, the hardware 335 that provides the platform for which the VM 330 operates, the relation to the information of the hardware 335 as indicated in the HDS 125, the service 315 that is being supported by the VNF 325, the product 310 connected to the service 315, the customer 305 connected to the product 310, the association of the VNF 325 to the VNF data store 135, the association of the VNF 325 to other VNFs and/or PNFs, etc. This information may be determined using any information that is received or through referencing the registry 150. In step 420, the registry device 140 records the information of the IC in the registry 150.

In step 425, the registry device 140 determines whether there is any change in the information for the IC. For example, there may be cause for the network device embodying the hardware 335 to be changed for the VM 330 to execute the VNF 325. In another example, there may be a new network device that is included in the network system 100. If the registry device 140 determines that there is no change in information for the IC through any direct or indirect connection, the registry device 140 continues to step 430. In step 430, the registry 150 is maintained for the IC.

However, if the registry device 140 determines that there is some change to the IC through a direct or indirect connection, the registry device 140 continues to step 435. In step 435, the registry device 140 determines all corresponding changes that accompany the registered change. That is, the registry device 140 may record the change and determine subsequent changes in light of the change. For example, if the IC is the VNF 325 and the change entails using a different VM 330, the subsequent changes may also incorporate the new VM 330 supporting the VNF 325, the new hardware supporting the VM 330, the correlation to the HDS 125, etc. Thus, in step 440, the registry device 140 may update the registry 150.

It should be noted that the method 400 may also be adapted for ICs that are already included in the registry 150. For example, the method 400 may include a step where an identification of the IC is received from which the information of the IC may be retrieved based upon the registry 150. The changes to the information of the IC may be performed as described above in steps 425-440.

The exemplary embodiments describe a device, system, and method for generating and maintaining a registry through tracking and managing objects and associations of ICs in a network system. The registry provides an accurate overview of the inter and intra relations of the ICs through the network system. As an object or relationship is instantiated, they may be recorded in the registry from lower level associations such as machine connections to higher level associations such as service and product connections. The registry may also be resilient in continuously being updated when any change in the information therein is altered where subsequent changes are also determined and recorded in the registry.

Through the exemplary embodiments, various advantages may be realized. The use of the registry for managing relationships of virtual resources and services and their temporal physical locations has various benefits. In a first example, the operating expense (OPEX) may be reduced from streamlined operations through dynamic tracking of resources that may be used and/or rapidly re-purposed for servicing customers, regardless of physical location to drive more efficient use of a service provider's assets and resources. The network assets across locations may run as desired as they are tracked and re-allocated for other uses in real time. Auto-registration with the registry as resources are on board may also eliminate labor intensive processes of manually activating the resources for service and correctly updating the inventory data stores. In a second example, revenues may be increased through rapid service introduction and iteration. That is, a service provider may be capable of introducing new or enhanced featured and available in a significantly shorter period of time. The ability to maintain and manage a hybrid network environment through a registry has importance for a seamless integration of such virtualized network features on top of a physical network. Furthermore, an effective, real time tracking of virtualized resources and their physical locations bring confidence in inserting and removing new service features fro the network to allow them to be tested in one physical location and rapidly switched to another physical location for service introduction in an iterative approach. In a third example, there may be improved service availability, network reliability, and customer service. The service and network troubleshooting may be significantly simplified through the registry that provides relationships among resources, services, customers, and locations. Fault and performance degradation events at the cloud infrastructure, network, and service layers may be correlated and root caused without having to identify multiple latent inventory databases to derive those relationships. Service resolution is also enhanced by the ability of the registry to pinpoint available resources in real time to enable impacted services to be re-instantiated at different physical locations seamlessly. Furthermore, the restoration priority of faults may be assessed by the number of impacted customers and/or by specific impacted customers via the registry such that the specific impacted customers may be notified proactively.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform, MAC OS, iOS, Android OS, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
in a registry:
recording, for an instantiated component (IC), an identification of the IC;
recording, for the IC, a location of the IC, wherein the location is one of a physical location or a virtual location;
recording, for the IC, a relation of the IC to a second IC;
receiving a change to one of the identification, the location, and the relation; and
recording the change and a further change to another one of the identification, the location, and the relation based upon the change.

2. The method of claim 1, wherein the IC is one of a virtual function, a virtual machine, a physical function, a hardware, a service, a product, and a customer.

3. The method of claim 2, wherein the relation is an association between one of the virtual function with the virtual machine, the virtual machine with the hardware, the service with the virtual function, the service with the physical function, the product with the service, the customer with the product, and the virtual function with a further virtual function.

4. The method of claim 2, wherein the service is supported by the virtual function which is supported by the virtual machine which is supported by the hardware.

5. The method of claim 1, wherein the relation is a plurality of relations and the second IC is a plurality of second ICs.

6. The method of claim 1, wherein the relation further includes an association to a data store.

7. The method of claim 6, wherein the data store is one of an infrastructure hardware data store, a physical function data store, a virtual function data store, and a combination thereof.

8. The method of claim 1, wherein the identification includes a minimum context to specifically identify the IC, the location, and the relation.

9. The method of claim 1, wherein the change and the further change is recorded when the change is received, the change being received at a substantially similar time when the change has occurred.

10. The method of claim 1, wherein the registry is used in a network function virtualization network architecture.

11. A registry device, comprising:
a network interface component configured to establish a connection to a network system; and
a processor configured to generate a registry by recording, for an instantiated component (IC) of the network system, an identification of the IC, recording a location of the IC, wherein the location is one of a physical location or a virtual location, and recording a relation of the IC to a second IC, the processor configured to maintain the registry by receiving a change to one of the identification, the location, and the relation and recording the change and a further change to another one of the identification, the location, and the relation based upon the change.

12. The registry device of claim 11, wherein the IC is one of a virtual function, a virtual machine, a physical function, a hardware, a service, a product, and a customer.

13. The registry device of claim 12, wherein the relation is an association between one of the virtual function with the virtual machine, the virtual machine with the hardware, the service with the virtual function, the service with the physical function, the product with the service, the customer with the product, and the virtual function with a further virtual function.

14. The registry device of claim 12, wherein the service is supported by the virtual function which is supported by the virtual machine which is supported by the hardware.

15. The registry device of claim 11, wherein the relation is a plurality of relations and the second IC is a plurality of second ICs.

16. The registry device of claim 11, wherein the relation further includes an association to a data store.

17. The registry device of claim 16, wherein the data store is one of an infrastructure hardware data store, a physical function data store, a virtual function data store, and a combination thereof.

18. The registry device of claim 11, wherein the identification includes a minimum context to specifically identify the IC, the location, and the relation.

19. The registry device of claim 11, wherein the change and the further change is recorded when the change is received, the change being received at a substantially similar time when the change has occurred.

20. A non-transitory computer readable storage medium with an executable program stored thereon, wherein the program instructs a microprocessor to perform operations comprising:
in a registry:
recording, for an instantiated component (IC), an identification of the IC;
recording, for the IC, a location of the IC, wherein the location is one of a physical location or a virtual location;
recording, for the IC, a relation of the IC to a second IC;
receiving a change to one of the identification, the location, and the relation; and
recording the change and a further change to another one of the identification, the location, and the relation based upon the change.
